(19) United States
(12) Patent Application Publication
(10) Pub. No.: US 2011/0161687 A1
(43) Pub. Date: Jun. 30, 2011

(54) POWER SUPPLY APPARATUS, POWER RECEPTION APPARATUS AND INFORMATION NOTIFICATION METHOD

(75) Inventor: SHIGERU TAJIMA, Kanagawa (JP)

(73) Assignee: SONY CORPORATION, Tokyo (JP)

(21) Appl. No.: 12/917,816

(22) Filed: Nov. 2, 2010

(30) Foreign Application Priority Data
Dec. 25, 2009 (JP) 2009-295581

(51) Int. Cl. G06F 1/26

(52) U.S. Cl. 713/300

(57) ABSTRACT

There is provided a power supply apparatus including a power supply unit configured to supply power, via a bus line, to another device with which an agreement about a power specification for power supply is achieved, a communication unit configured to communicate between power supplied from the power supply unit and the another device using frequency dividing, and an state input unit configured to accept an input of one or more predetermined states from outside. When the predetermined state is input to the state input unit, the communication unit applies a parameter indicating the state and communicates with the another device.

### BACKGROUND OF THE INVENTION

1. Field of the Invention

The present invention relates to a power supply apparatus, a power reception apparatus and an information notification method, more specifically, to a power supply apparatus, a power reception apparatus and an information notification method in which electric power and information are frequency-divided and can be used at the same time.

2. Description of the Related Art

Many of an electronic device such as a personal computer and a game machine use an AC adaptor, which inputs an alternating-current (AC) power from a commercial power supply and outputs electric power matching the device, for the purpose of the operation of the device and the charge of the battery. Although the electronic device is usually operated by a direct current (DC), the voltage and current are different in each device. Thus, the AC adaptor outputting electric power matching each device is also different for each device. Thus, even if AC adaptors have similar shapes, they are incompatible with each other, and there is an issue that the number of AC adaptors increases with increasing numbers of devices.

In order to solve the above issue, there has been proposed a power bus system in which a power supply block supplying electric power to devices such as a battery and an AC adaptor and a power consumption block receiving electric power from the power supply block are connected to a common DC bus line (for example, Patent Literatures 1 and 2). In this power bus system, a DC current flows through a bus line. Further, in the power bus system, each block itself is described as an object, and the objects of the respective blocks mutually transmit and receive information (state data) through a bus line. The object of each block generates the information (state data) based on a request from the object of another block and transmits the information as reply data. The object of the block having received the reply data can control electric power supply and consumption based on the contents of the received reply data.

### SUMMARY OF THE INVENTION

Similarly to the power supply network in the related art, it is assumed that power supply is lost in case of emergency, especially in case of a natural disaster in the above-described power source bus system. Regarding the above described power source bus system, in case of emergency, if the state is detected and notified to other devices in the system, it is possible to efficiently perform a suspension of power supply and power reception, and a recovery of power supply and power reception from the emergency state.

In view of the foregoing, it is desirable to provide a novel and improved power supply apparatus, power reception apparatus and information notification method capable of detecting a predetermined state, notifying the detected state to another device, and controlling operation according to the state.

According to an embodiment of the present invention, there is provided a power supply apparatus including a power supply unit configured to supply power, via a bus line, to another device with which an agreement about a power specification for power supply is achieved, a communication unit configured to communicate between power supplied from the power supply unit and the another device using frequency dividing, and an state input unit configured to accept an input of one or more predetermined states from outside. When the predetermined state is input to the state input unit, the communication unit applies a parameter indicating the state and communicates with the another device.

The power supply apparatus may further include a cancel unit configured to cancel the application of the parameter by the communication unit in the communication with the another device.

The power supply apparatus may further include a state confirmation unit configured to confirm whether normal power supply with the another device is available when the communication unit starts to communicate with the another device using the applied parameter.

The state confirmation unit may confirm whether normal power supply with the another device is available by confirming impedance of the bus line.

The power supply apparatus may further include a message transmission unit configured to transmit a predetermined message corresponding to the predetermined state to a previously specified another device when the state is input to the state input unit.

Even when the predetermined state is input to the state input unit, the communication unit need not communicate with the another device using the applied parameter indicating the state depending on the type of the state.

According to another embodiment of the present invention, there is provided a power reception apparatus including a power reception unit configured to receive power through a predetermined bus line from a power supply apparatus with which an agreement about a power specification for power supply is achieved, a communication unit configured to communicate between power received by the power reception unit and the power supply apparatus using frequency dividing, and a display output unit configured to execute a predetermined display corresponding to a predetermined state when the communication unit receives information with a parameter indicating the state from the power supply apparatus.

The power reception apparatus may further include a power accumulation unit configured to accumulate power received by the power reception unit. When the communication unit receives the information with the parameter indicating the predetermined state from the power supply apparatus, the power reception unit may suspend the power reception from the power supply apparatus and starts to operate using the power accumulated in the power accumulation unit.

The power reception apparatus may further include a message transmission unit configured to transmit a predetermined message corresponding to the predetermined state to a previously specified another device when the communication unit receives the information with the parameter indicating the state from the power supply apparatus.

According to another embodiment of the present invention, there is provided an information notification method, including the steps of supplying power to another device with which an agreement about a power specification for power supply is achieved, accepting an input of one or more predetermined states from outside, and communicating between power supplied in the step of supplying power and the another device using frequency dividing and communicating with the another device by applying a parameter indicating the predetermined state when the state is input in the step of accepting an input.

As described above, the present invention provides a novel and improved power supply apparatus, power reception apparatus and information notification method capable of detecting a predetermined state and notifying the detected state to another device.

### BRIEF DESCRIPTION OF THE DRAWINGS

FIG. 1 is an explanatory view showing a constitution of a power supply system according to an embodiment of the present invention;

FIG. 2 is an explanatory view showing a power supply processing by a power supply system 1 according to the embodiment of the present invention;

FIG. 3 is an explanatory view showing a constitution of a power supply server 100 according to the embodiment of the present invention;

FIG. 4 is an explanatory view showing an arrangement of the client 200 according to the embodiment of the present invention; and

FIG. 5 is an explanatory view showing an arrangement of the client 200′ according to the embodiment of the present invention.

### DETAILED DESCRIPTION OF THE EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Descriptions will be made in the following order:
<1. An embodiment of the present invention>

(1-1. Constitution of power supply system)

(1-2. Power supply processing by power supply system)

(1-3. Constitution of power supply server)

(1-4. Operation of power supply server)

(1-5. Constitution of client)

### <2. Conclusion>

### 1. AN EMBODIMENT OF THE PRESENT INVENTION

### 1-1. Constitution of Power Supply System

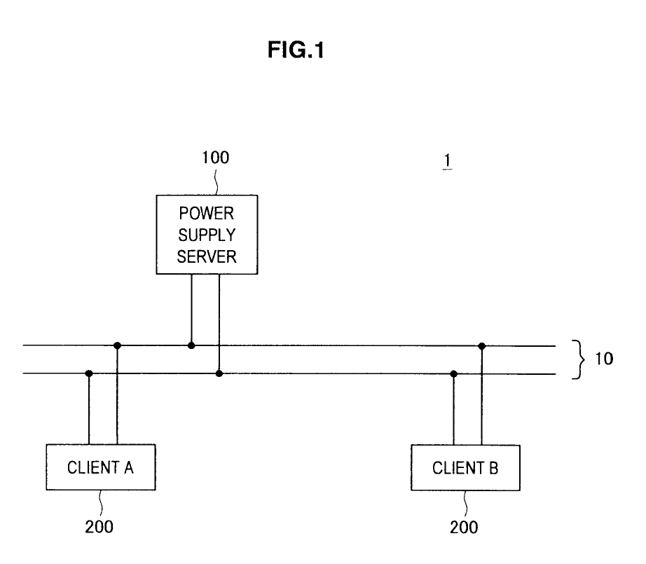

First, a constitution of a power supply system according to an embodiment of the present invention will be described. FIG. 1 is an explanatory view showing the constitution of the power supply system according to the embodiment of the present invention. Hereinafter, the constitution of the power supply system according to the embodiment of the present invention will be described using FIG. 1.

As shown in FIG. 1, a power supply system 1 according to an embodiment of the present invention is configured to include a power supply server 100 and a client 200. The power supply server 100 and the client 200 are connected to each other through a bus line 10.

The power supply server 100 supplies DC power to the client 200. The power supply server 100 further transmits and receives an information signal to and from the client 200. In the present embodiment, the DC power supply and the transmission and reception of the information signal between the power supply server 100 and the client 200 are shared on the bus line 10.

The power supply server 100 is configured to include a communication modem for use in transmitting and receiving the information signal and a microprocessor for use in controlling an electric power supply, and a switch controlling a DC power output.

The client 200 receives the DC power supply from the power supply server 100. The client 200 further transmits and receives the information signal to and from the power supply server 100. In FIG. 1, the two clients 200 are illustrated.

The client 200 is configured to include a communication modem for use in transmitting and receiving the information signal and a microprocessor for use in controlling the electric power supply, and a switch controlling the DC power output.

In the power supply system 1 shown in FIG. 1, the single power supply server 100 and the two clients 200 are illustrated. However, in the present invention, the number of the power supply servers and the number of the clients are not obviously limited to the example.

Since a method of supplying electric power in the power supply systems 1 and 2 shown in FIG. 1 is described in the Patent Literature 2 (Japanese Patent Application Laid-Open No. 2008-123051), the detailed description will be omitted. However, hereinafter, a power supply processing by the power supply system 1 according to an embodiment of the present invention will be briefly described.

### 1-2. Power Supply Processing by Power Supply System

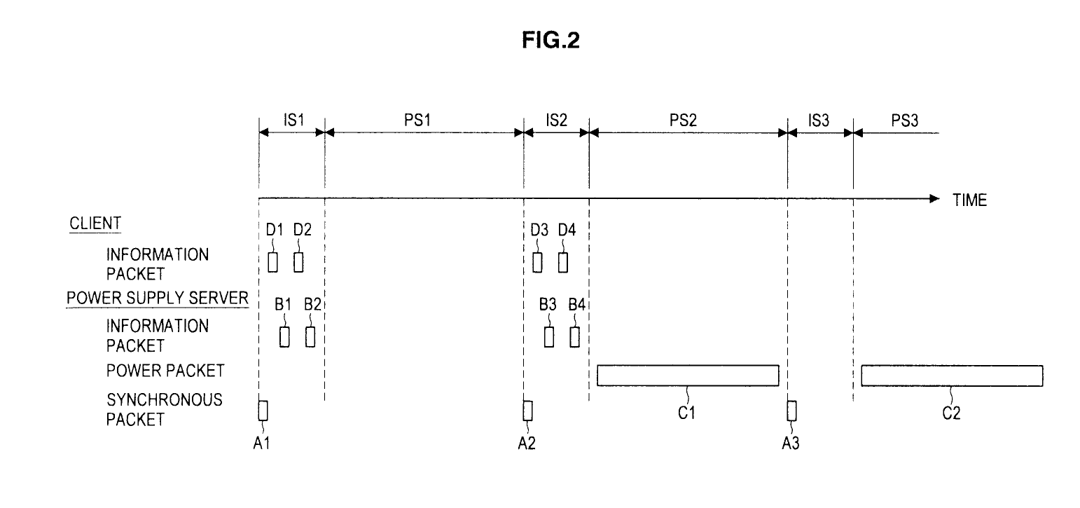

FIG. 2 is an explanatory view for explaining the power supply processing by the power supply system 1 according to an embodiment of the present invention. Hereinafter, the power supply processing by the power supply system 1 according to each of the embodiments of the present invention will be described using FIG. 2.

As shown in FIG. 2, the power supply server 100 periodically outputs synchronous packets A1, A2, A3, and . . . to the bus line 10. The power supply server 100 further outputs information packets B1, B2, B3, and . . . and power packets C1, C2, C3, and . . . so as to supply electric power to the client 200. The information packets B1, B2, B3, and . . . are the information signals transmitted and received to and from the client 200, and the power packets C1, C2, C3, and . . . are obtained by packetizing an electric power energy. Meanwhile, the client 200 outputs information packets D1, D2, D3, and . . . that are the information signals transmitted and received to and from the power supply server 100 so as to receive electric power supply from the power supply server 100.

The power supply server 100 outputs the synchronous packets A1, A2, A3, and . . . at the start of a time slot of a predetermined interval (for example, every 1 second). The time slot includes an information slot through which the information packet is transmitted and a power slot through which the power packet is transmitted. Information slots IS1, IS2, IS3, and . . . are sections where the information packets are exchanged between the power supply server 100 and the client 200. Power supply slots PS1, PS2, PS3, and . . . are sections where the power packets C1, C2, C3, and . . . supplied from the power supply server 100 to the client 200 are output. The information packet is a packet capable of performing output only in the sections of the information slots IS1, IS2, IS3, and . . . . Thus, when the transmission and reception of the information packet is not completed in one information slot, the information packet is transmitted over a plurality of information slots. Meanwhile, the power packet is a packet capable of performing output only in the sections of the power supply slots PS1, PS2, PS3, and . . . .

The power supply server 100 has one or two or more server power supply profiles showing a power specification that can be supplied by itself. The client 200 receives the electric power supply from the power supply server 100 which can supply electric power matching to its own specification. At this time, the client 200 obtains a server power supply profile from the power supply server 100 and determines the specification (server power supply profile) of the power supply server 100 for the client 200 itself. Specifically, the client 200 first detects a synchronous packet A1 to be output to the power supply server 100 and obtains the address of the power supply server 100 included in the synchronous packet A1. The address may be a MAC address, for example. Next, the client 200 transmits to the power supply server 100 an information packet D1 that requests transmission of the number of the server power supply profiles possessed by the power supply server 100.

The power supply server 100 having received the information packet D1 transmits a server power supply profile number in the information packet B1. The server power supply profile number is the number of the server power supply profiles of the power supply server 100. The client 200 having received the information packet B1 obtains from the power supply server 100 the contents of the server power supply profile with the number equal to the number of the server power supply profiles of the power supply server 100. For example when the power supply server 100 has two server power supply profiles, the client 200 first obtains one of the two server power supply profiles. The client 200 having received one of the two server power supply profiles transmits to the power supply server 100 the server power supply profile as the information packet D2 requesting the use of the power supply.

The power supply server 100 having received the information packet D2 transmits a first server power supply profile as the information packet B2 to the client 200. The first server power supply profile is stored in a storage part (not shown) included in the power supply server 100. The client 200 having received the information packet B2 from the power supply server 100 transmits the information packet for use in obtaining a second server power supply profile. However, the information slot IS1 terminates at this point, and the power supply slot PS1 for use in transmitting the power supply packet starts. Thus, this information packet is transmitted in the next information slot IS2. In the power supply slot PS1, since the power specification that the client 200 receives electric power from the power supply server 100 is not determined, and the electric power supply is not performed.

The power slot PS1 terminates, and the synchronous packet A2 showing the start of the next time slot is output from the power supply server 100. Thereafter, the client 200 having received the information packet B2 from the power supply server 100 transmits the information for use in obtaining the second server power supply profile as the information packet D3.

The power supply server 100 having received the information packet D3 transmits the second server power supply profile as the information packet B3 to the client 200. The second server power supply profile is stored in a storage part (not shown) included in the power supply server 100. The client 200 having received the information packet B3 to obtain the two server power supply profiles of the power supply server 100 selects the server power supply profile with a power specification matching to the client 200 itself. The client 200 then transmits to the power supply server 100 the information packet D4 for use in determining the selected server power supply profile.

The power supply server 100 having received the information packet D4 transmits information, which serves as the information packet B4 and represents such a response that the power specification is determined, to the client 200 so as to notify the completion of the determination of the first server power supply profile to the client 200. Thereafter, when the information slot IS2 terminates and the power slot PS2 starts, the power supply server 100 outputs the power supply packet C1 to the client 200 and performs power supply. With regard to the timing of transmission of the power packet, a power supply start time can be designated by the client 200 to the power supply server 100 by using the information representing a transmission start time setting request.

The power supply processing by the power supply system 1 according to one embodiment of the present invention has been explained. Next, the constitution of the power supply server 100 according to one embodiment of the present invention will be explained.

### 1-3. Constitution of Power Supply Server

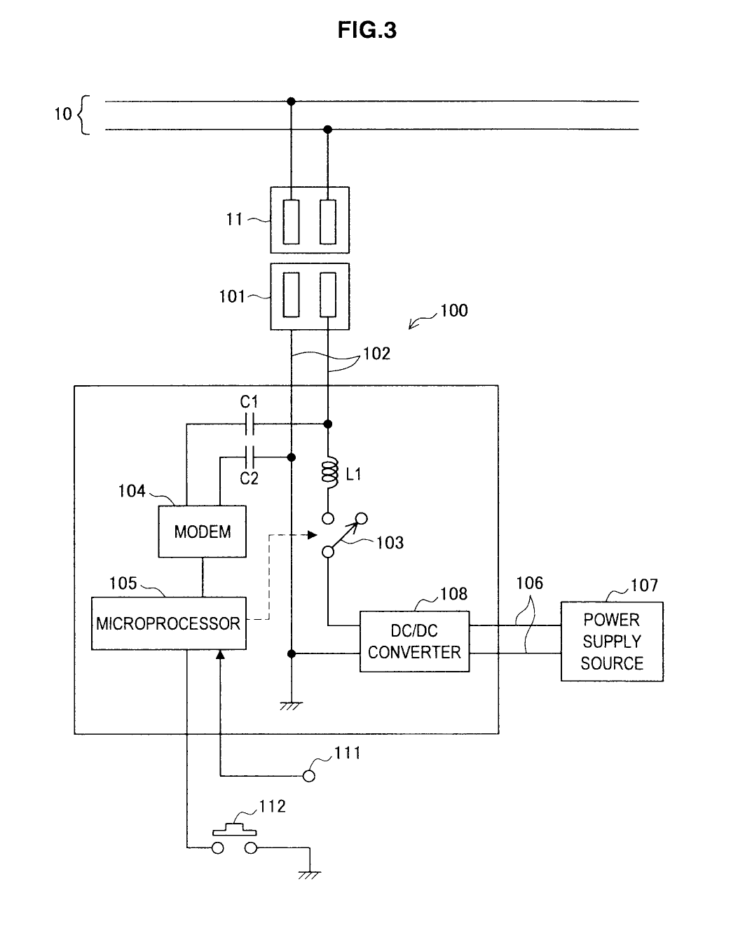

FIG. 3 is an explanatory view showing a constitution of the power supply server 100 according to the embodiment of the present invention. Hereinafter, the constitution of the power supply server 100 according to the embodiment of the present invention will be described using FIG. 3.

As shown in FIG. 3, the power supply server 100 according to the embodiment of the present invention is configured to include a connector 101, connecting wires 102 and 106, a main switch 103, a modem 104, a microprocessor 105, a power supply source 107, a DC/DC converter 108, a signal input terminal 111, a reset switch 112, capacitors C1 and C2, and an inductor L1.

The connector 101 connects a power supply server body and the bus line 10 by connecting to the connector 11 of the bus line 10. The connecting wire 102 is used for connecting the connector 101 and the power supply server body. The main switch 103 controls an electric power output. When the main switch 103 is turned on, the power supply server 100 can supply electric power from the power supply source 107 to the bus line 10. Meanwhile, when the main switch 103 is turned off, the power supply server 100 can stop the electric power supply from the power supply source 107.

The modem 104 is used for transmitting and receiving information to and from other power supply server and client connected to the bus line 10. The modem 104 transmits high frequency signals used for communication to the bus line 110, and receives the high frequency signals used for communication that is travelling through the bus line 10. Note that the capacitors C1 and C2 are arranged between the bus line 10 and the modem 104, to prevent the DC current traveling through the bus line 10 from flowing into the modem 104.

The microprocessor 105 controls the operation of the power supply server 100. When negotiation between the power supply server 100 and the client (for example, the client 200 of FIG. 1) are completed, the microprocessor 105 turns on the main switch 103 so that electric power is supplied from the power supply source 107.

The connecting wire 106 is used for connecting the power supply server body and the power supply source 107. The power supply source 107 is configured to supply electric power of DC voltage for example and can supply DC power to the bus line 10 when the main switch 103 of the power supply server 100 is turned on. As the power supply source 107, a solar panel or the like that generates electric power using sunlight irradiation for example may be used.

The DC/DC converter 108 is configured to convert a voltage of electric power supplied by the power supply source 107 into a certain proper voltage. Since the voltage is converted in the DC/DC converter 108, electric power can be supplied at a voltage matching to a request of a client receiving a power supply from the power supply server 100. Note that the DC/DC converter 108 may be a step-down DC/DC converter that inputs voltage around 7 to 30 V, for example.

The signal input terminal 111 is a terminal for use in receiving a supply of a signal indicating a predetermined state for the microprocessor 105 of the power supply server 100. The signal indicating the predetermined state is for example an emergency earthquake alert delivered from the Meteorological Agency and indicating an occurrence of an earthquake or information of detecting fire notified by a home fire alarm or the like. Upon receiving the signal indicating the predetermined state from the signal input terminal 111, the microprocessor 105 can generate a packet corresponding to the sate and supply to the bus line 10.

The reset switch 112 is a switch for resetting the operation of the power supply server 100 to a normal operation and, when the reset switch 112 is pressed, the operation of the power supply server 100 is reset to a normal operation, that is, transmitting and receiving information and supplying power from the power supply source 107.

The constitution of the power supply server 100 according to an embodiment of the present invention has been described using FIG. 3. Next, operation of the power supply server 100 and the client 200 that receives electric power from the power supply server 100 will be explained.

### 1-4. Operation of Power Supply Server

The power supply server 100 having the constitution shown in FIG. 3 and the client 200 that receives electric power from the power supply server 100 operate as follows. This example describes a case where the power supply server 100 also serves as a synchronous server and periodically transmits a synchronous packet.

(1) When a signal indicating a predetermined state is supplied from the signal input terminal 111, the power supply server 100 outputs a synchronous packet with an emergency mode parameter corresponding to the state to the bus line 10. Hereinafter, a condition in which the power supply server 100 outputs a synchronous packet with an emergency mode parameter is referred to as an “emergency operation mode.”

Here, since the emergency is not limited to an occurrence of an earthquake, when the content of emergency is indicated in the emergency mode parameter, the power supply server and clients can operate differently from the normal mode. For example, the following may be defined as parameters for emergency:

| | | |
|---|---|---|
| Emergent | Value | Contents |

| | |
|---|---|
| 0x01 | earthquake |
| 0x02 | storm |
| 0x04 | flood |
| 0x08 | earth slide |
| 0x10 | fire |
| 0x20 | blackout |

Here, since plural emergency situations may occur at the same time, it is preferable that the parameter value be processable in OR operation. In this explanation, the constitution and method for determining the emergency mode are omitted. This embodiment simply exemplifies a case of detecting a type of an emergency mode.

(2) When an emergency mode parameter is applied to the synchronous packet transmitted from the power supply server 100, the client 200 having received the synchronous packet from the power supply server 100 checks its power request priority. When the power request priority is equal to or lower than a certain reference value and electric power is being received, the client 200 promptly requests a suspension of the power supply to the power supply server 100. In a case where the client 200 is not receiving electric power, the client 200 does not newly request power supply.

(3) Among the clients 200, a client that is desired to operate in emergency (for example, a client that has a function to light an emergency light or a function to issue an emergency alarm) is given priority for operation and requests a re-supply of power to the power supply server 100 according to need. Here, it is preferable to provide a backup power source to such a client which is desired to operate in emergency.

(4) The power supply server 100 selected as a synchronous server executes housekeeping of the power supply system 1, especially an impedance check of the bus line 10 to determine or estimate a connection condition of the bus line 10 whenever a reference time period (3 minutes, for example) has passed after an input signal is supplied to the signal input terminal 111 of the power supply server 100. The housekeeping of the power supply system 1 is executed by, for example, the microprocessor 105 to check damage of an electrical wire caused by a disaster and reconstruct the power supply system 1 according to need. Further, the housekeeping of the power supply system 1 is periodically executed at proper intervals (10 minutes, for example) until the reset switch 112 of the power supply server 100 is pressed and the emergency operation mode is reset so as to deal with further damage of electrical wire.

More specifically, the housekeeping of the power supply system 1 by the synchronous server (the power supply server 100) is executed by specifying one impedance value in advance and observing whether or not the impedance of the bus line 10 is equal to or greater than the value. The client 200 connected to the bus line 10 in which the impedance value is equal to or greater than the specified value is controlled by the synchronous server (the power supply server 100) to suspend power supply from the power supply server 100. In addition, the synchronous server may maintain measured impedance values of the bus line 10 and execute housekeeping by observing the temporal change in the measured impedance values of the bus line 10 and estimating damage of the bus line 10.

(5) The emergency operation mode is canceled when the reset switch 112 of the power supply server 100 is pressed.

In the power supply server 100 having the constitution shown in FIG. 3, switching to the emergency operation mode is executed when an input to the signal input terminal 111 is detected; however, the present invention is not limited to this example. For example, the power supply server 100 may be provided with an input line or a switch for use in testing. With such an input line or a switch, it is possible to periodically test if the power supply server 100 operates in the emergency operation mode for example.

With the power supply server 100 having the above constitution, in a case where the power supply server 100 operates in an emergency operation mode, the power consumption is suppressed by releasing as many clients 200 connecting to the power supply system 1 as possible so that it is possible to maintain electric power such as a battery, which may be provided in the power supply system 1, and control the client that is desired to operate in emergency to operate.

The operation of the power supply server 100 according to one embodiment of the present invention has been described. It is preferable that, when a synchronous packet with an emergency mode parameter is transmitted from the synchronous server, the client 200 having received the synchronous packet operate differently from the operation in a normal condition. More specifically, it is preferable that the client 200 having received the synchronous packet appeal the existence of the device to the user or appeal that the electric power is available. Next, the constitution of the client 200 that executes the following operation will be described.

### 1-5. Constitution of Client

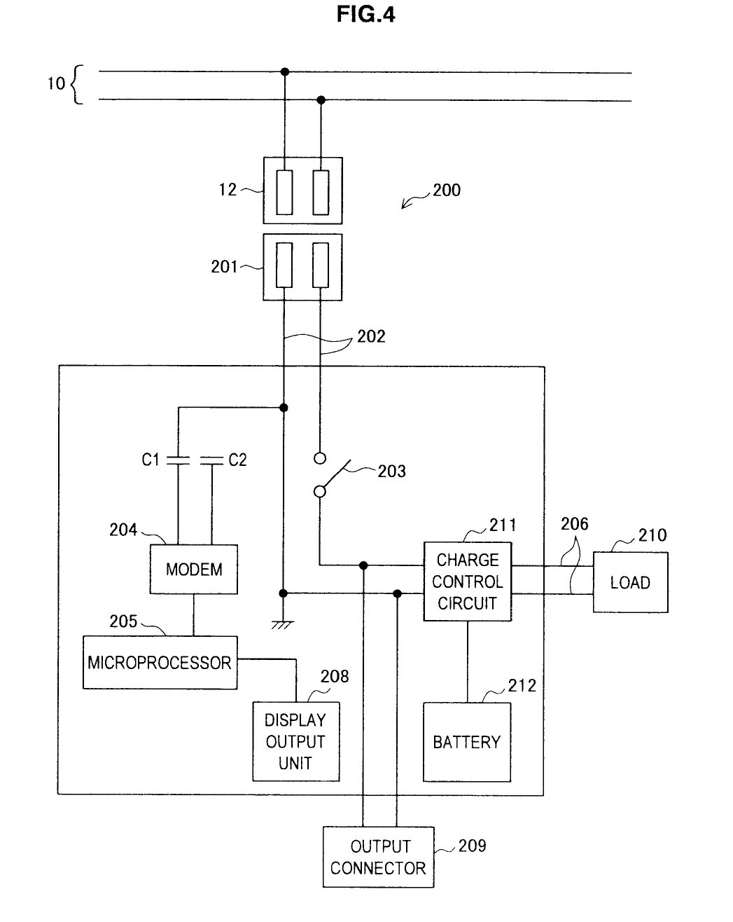

FIG. 4 is an explanatory view showing a constitution of the client 200 according to an embodiment of the present invention. Hereinafter, the constitution of the client 200 according to an embodiment of the present invention will be described using FIG. 4.

As shown in FIG. 4, the client 200 according to an embodiment of the present invention is configured to include a connector 201, connecting wires 202 and 206, a main switch 203, a modem 204, a microprocessor 205, a display output unit 208, an output connector 209, a load 210, a charge control circuit 211, a battery 212, and capacitors C1 and C2.

The connector 201 connects the client body and the bus line 10 by connecting to the connector 12 of the bus line. The connecting wire 202 is used for connecting the connector 201 and the client body. The main switch 203 controls an electric power input. When the main switch 203 is turned on, the client 200 can receive electric power supplied from the power supply server via the bus line 10. Meanwhile, when the main switch 203 is turned off, the client 200 does not receive electric power supplied from the power supply server.

The modem 204 is used for transmitting and receiving information to and from other power supply server and client connected to the bus line 10. The modem 204 transmits high frequency signals used for communication to the bus line 10, and receives the high frequency signals used for communication that are traveling through the bus line 10. Between the bus line 10 and the modem 204, there are capacitors C1, C2 to prevent the DC current traveling through the bus line 10 from being introduced into the modem 204.

The microprocessor 205 controls operation of the client 200 and monitors voltage and electric current inside the client 200. When negotiation between the power supply server (for example, the power supply server 100 of FIG. 1) and the client 200 is completed, the microprocessor 205 turns on the main switch 203 to receive electric power from the power supply server.

Upon receiving the synchronous packet with the emergency mode parameter, the microprocessor 205 controls a later-described display output unit 208 to perform a predetermined output. It is possible to show a state of the client 200 to the user by controlling the display output unit 208 to perform the predetermined output.

The connecting wire 206 is used for connecting the client body and the load 210.

The display output unit 208 performs a predetermined output under the control of the microprocessor 205 when the synchronous packet with the emergency mode parameter is received. The display output unit 208 includes, as an example, at least one of the following functions: (1) a battery 212 battery level indication function, (2) a nominal output voltage display function, (3) a power source existence display function, (4) a signal tone generation function, (5) a radio beacon signal generation function, (6) an illumination function, and the like.

The output connector 209 is used for outputting electric power accumulated in the battery 212 and, when another device is connected to the output connector 209, the electric power accumulated in the battery 212 can be supplied to the another device. The output connector 209 may be a charging terminal of a mobile phone or a USB terminal (which may just emulate a USB power supply function, not the USB function itself).

The load 210 consumes electric power supplied from the power supply server. The charge control circuit 211 is a circuit for controlling a charge and a discharge of the battery 212. The battery 212 accumulates electric power supplied from the power supply server under the control of the charge control circuit 211 and discharges the accumulated electric power to the load 210 under the control of the charge control circuit 211.

An example of the constitution of the client 200 according to an embodiment of the present invention has been described. Next, an example of operation of the client 200 according to an embodiment of the present invention will be explained.

Here, as an example of the client 200, an emergency light including a built-in battery will be explained. In the following explanation, the load 210 is illumination. Emergency lights, which include a built-in battery and are lit when detecting an earthquake for example, are commercially available. The emergency light including a built-in battery explained here corresponds to the power supply system 1 and executes the following operation for example.

In a normal mode, the emergency light monitors the battery level of its battery 212 and requests the power supply server 100 to supply electric power according to need so as to maintain the battery 212 in a fully charged state. Further, the display output unit 208 displays information according to the charged level of the battery 212 (for example, lights an LED or the like according to the charged level of the battery 212). For example, a green light blinks when the battery 212 is in a fully charged state and a red light blinks when the battery 212 is being charged (here, it is not preferable to constantly light the LED or the like to prevent unnecessary power consumption).

When the microprocessor 205 detects a synchronous packet with an emergency mode parameter from the synchronous server, the microprocessor 205 periodically blinks the light. Here, when a speaker is built in the emergency light, the microprocessor 205 may sound an alarm tone so that the user can easily recognize the location of the emergency light. In this case, it is preferable that the power consumption be suppressed by shortening the blinking period or the like as much as possible to reduce the duty.

For example, when the microprocessor 205 detects a parameter indicating a blackout in the above parameter, it is preferable that the client 200 switch to the emergency operation mode and light the alarm (during an intermittent lighting of the main light, an audible tone is intermittently generated). On the other hand, when a parameter indicating a storm is detected in the above parameter, it may be possible to control the client 200 not to switch to the emergency operation mode. Further, when the microprocessor 205 detects other parameters (earthquake, flood, earth slide or fire) in the above parameter, it is preferable that the client 200 switch to the emergency operation mode. Then, in a case of switching to the emergency operation mode, the microprocessor 205 may disconnect the main switch 203 and control the client 200 to operate using the electric power accumulated in the battery 212.

The above described emergency mode parameter is used for the power supply server 100 serving as a power generation source in addition to the client 200 of the power supply system 1. For example, in a case where the power source of the power supply server 100 is an aerogenerator, when the microprocessor 105 of the power supply server 100 obtains an emergency mode parameter that is a parameter indicating “storm,” the power supply server 100 can operate in a mode corresponding to the emergency mode parameter before the aerogenerator rotates at extremely high speeds (on the other hand, when other parameter is received, the power supply server 100 may ignore the parameter and continue to generate power).

Such an emergency mode parameter is used as information for the power supply server 100 or the client 200 to survive as long as possible in emergency and realize a robust operation. It is noted that the power supply server 100 and the client 200 may display the received emergency mode parameter.

Here, the client 200 may be provided with a switch that allows to control constantly turning on or constantly turning off the light. In a case where the client 200 can detect a synchronous packet (in other words, it is connected to the bus line 10 and operates under the control of the power supply system 1), even when the power is turned off using the switch, the light is turned on according to the detection of the synchronous packet with the emergency mode parameter. In a condition where a synchronous packet cannot be detected, that is, in a condition where the client 200 is physically disconnected from the bus line 10, the client 200 simply operates as an emergency light.

The client 200 serving as an emergency light has a function for supplying power to another device by the output connector 209 in addition to an illuminating function in case of emergency. As described above, the output connector 209 may be a charging terminal of a mobile phone or a USB terminal for example and may supply voltage of about 5 V to another device by the USB terminal for example.

One example of operation of the client 200 according to one embodiment of the present invention has been described.

In the above explanation, it is assumed that the power line (of the exiting grid) is suspended in case of emergency such as an occurrence of a disaster; however, when the power line is not suspended and power supply continues, each device in the power supply system 1 may not operate in the emergency operation mode as described above. In this case, the power supply server 100 shown in FIG. 3 is provided with means for detecting presence or absence of power supply in the existing AC line to monitor the state of the AC line so that the power supply server 100 can detect the power line is in operation even though an emergency signal is received.

In a case where there is power supply by the exiting grid, each device in the power supply system 1 may continue normal operation while the power supply system 1 does not switch to the emergency operation mode at all; however, when the power supply server 100 receives an emergency signal (for example, a signal notifying an occurrence of an earthquake), the power supply server 100 may execute housekeeping after a certain proper period of time has passed even when there is power supply by the exiting grid as described above.

Further, it depends on a design matter of the client whether the client having a function to turn on an emergency light as described above turns on the light even when there is power supply by the exiting grid. Such a client may turn on the emergency light in response to a synchronous packet with an emergency mode parameter from the synchronous server or may be provided with an earthquake sensor or the like and turn on the light based on a detection by the sensor.

Note that when the power supply system 1 has a real-time clock function, this may allow to execute different controls on the respective clients according to the time zone of the day. Similarly, when the client has an illuminance sensor, turning on and off the light may be controlled based on the peripheral illuminance in addition to the condition of the power supply by the exiting grid.

In a case where the power supply system 1 can detect an occurrence of an emergency (even if the emergency is detected based on an input from another system), the information of the emergency may be notified to other systems or other power supply systems. To notify this information, the client 200 may be provided with wireless or wired communication means other than the bus line 10 and notify the information using the communication means.

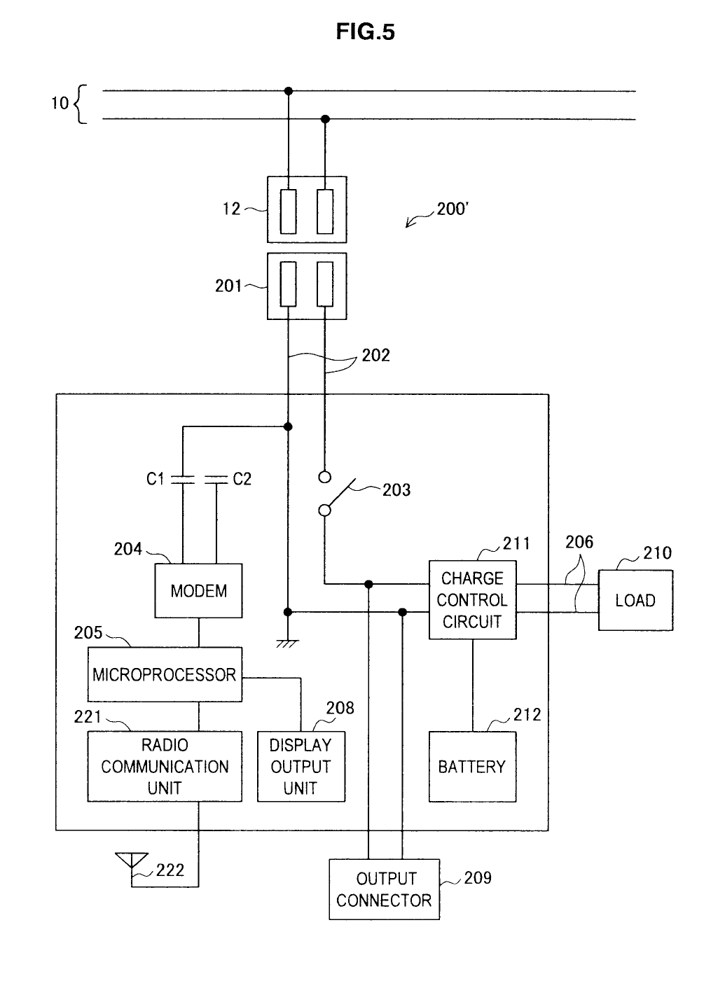

FIG. 5 is an explanatory view showing a constitution of a client 200′ which is a modification example of the client 200 according to one embodiment of the present invention. The client 200′ shown in FIG. 5 is connected to the power supply system 1 to receive power supply and further includes a radio communication unit 221 and an antenna 222 in addition to the constitution of the client 200 shown in FIG. 4.

The occurrence of an emergency is notified by transmitting a synchronous packet with an emergency mode parameter from the power supply server 100 to the client 200′ via the bus line 10. When the client 200′ detects the occurrence of the emergency, the radio communication unit 221 radio-transmits emergency information indicating an occurrence of an emergency from the antenna 222 using a communication protocol specified among other systems in advance. From the antenna 222, parameters indicating an occurrence of an emergency and the emergency are radio-transmitted.

In other words, the signal radio-transmitted from the client 200′ is sent to another system and the another system operates according to the content of the signal. For example, when the radio communication unit 221 is an FM transmitter for radio-transmitting signals using a specific frequency and the content to be radio-transmitted is previously recorded audio information, an FM receiver applicable to the signals radio-transmitted from the client 200′ can receive the signals.

Further, for example, when the radio communication unit 221 has a function for transmitting information of emergency to specific addresses via a wireless LAN, the radio transmission by the radio communication unit 221 can notify users in a wide area of the occurrence of the emergency and an owner or a manager of the power supply system 1 can be notified of the occurrence of the emergency even when they are away from the system.

Further, the transmission of the emergency information may be executed in every certain period of time, not only immediately after the occurrence of the emergency (until the power source of the power supply system 1 is exhausted), and a temporal operation transition of the power supply system 1 (for example, information of housekeeping result by the power supply system 1) can be recognized. Note that, when the radio communication unit 221 has a function for directly connecting to the Internet, the user of the power supply system 1 can inquire about the temporal operation transition of the power supply system 1 via the Internet.

The client 200′ as a modification example of the client 200 according to one embodiment of the present invention has been described. Here, in the modification example, the radio communication unit 221 and antenna 222 are provided in the client 200′ which receives the synchronous packet from the synchronous server; however, the present invention is not limited to this example and a radio communication function may be provided in the power supply server 100.

### 2. CONCLUSION

As described above, according to one embodiment of the present invention, the power supply server 100 has the signal input terminal 111 for receiving a notification of an occurrence of an emergency and transmits a synchronous packet with a proper parameter (an emergency mode parameter) according to the type of the signal input via the signal input terminal 111 to the bus line 10.

Since an internal power source (mainly, a battery or a solar battery system or the like) is basically included, the power supply system 1 probably survives even if the exiting grid is damaged by a disaster. Focusing on this point, in this embodiment, disaster information is reflected or broadcasted by a system independent from the exiting grid so that recognizing means and energy saving means can be secured at the time of the disaster.

Further, the power supply system 1 normally serves as an energy management system and used for disaster information communication in case of emergency such as a disaster so that the system which constantly operates is simply applied in the disaster case. This increases reliability in general, compared to a system that operates only in disaster case.

It should be understood by those skilled in the art that various modifications, combinations, sub-combinations and alterations may occur depending on design requirements and other factors insofar as they are within the scope of the appended claims or the equivalents thereof.

For example, according to this embodiment, the power supply server 100 is provided with the signal input terminal 111 for receiving a notification of an occurrence of an emergency and transmits a synchronous packet with a proper parameter (an emergency mode parameter) to the bus line 10 according to the type of the signal input to the signal input terminal 111; however, the present invention is not limited to this example. For example, the client 200 is also provided with a similar signal input terminal and, when the client 200 detects an occurrence of an emergency, the occurrence of the emergency may be notified by being radio-transmitted or wired-transmitted via the bus line 10 to the synchronous server (the power supply server 100). Then, the synchronous server having received the occurrence of the emergency from the client 200 may transmit a synchronous packet with a proper parameter (an emergency mode parameter) to the bus line 10.

The present invention is applicable to a power supply apparatus, a power reception apparatus and an information notification method, more specifically, to a power supply apparatus, a power reception apparatus and an information notification method in which electric power and information are frequency-divided and can be used at the same time.

The present application contains subject matter related to that disclosed in Japanese Priority Patent Application JP 2009-295581 filed in the Japan Patent Office on Dec. 25, 2009, the entire content of which is hereby incorporated by reference.

What is claimed is:

1. A power supply apparatus comprising:
a power supply unit configured to supply power, via a bus line, to another device with which an agreement about a power specification for power supply is achieved;
a communication unit configured to communicate between power supplied from the power supply unit and the another device using frequency dividing; and
an state input unit configured to accept an input of one or more predetermined states from outside,
wherein, when the predetermined state is input to the state input unit, the communication unit applies a parameter indicating the state and communicates with the another device.

2. The power supply apparatus according to claim 1, further comprising:
a cancel unit configured to cancel the application of the parameter by the communication unit in the communication with the another device.

3. The power supply apparatus according to claim 1, further comprising:
a state confirmation unit configured to confirm whether normal power supply with the another device is available when the communication unit starts to communicate with the another device using the applied parameter.

4. The power supply apparatus according to claim 3,
wherein the state confirmation unit confirms whether normal power supply with the another device is available by confirming impedance of the bus line.

5. The power supply apparatus according to claim 1, further comprising:
a message transmission unit configured to transmit a predetermined message corresponding to the predetermined state to a previously specified another device when the state is input to the state input unit.

6. The power supply apparatus according to claim 1,
wherein even when the predetermined state is input to the state input unit, the communication unit does not communicate with the another device using the applied parameter indicating the state depending on the type of the state.

7. A power reception apparatus comprising:
a power reception unit configured to receive power through a predetermined bus line from a power supply apparatus with which an agreement about a power specification for power supply is achieved;
a communication unit configured to communicate between power received by the power reception unit and the power supply apparatus using frequency dividing; and
a display output unit configured to execute a predetermined display corresponding to a predetermined state when the communication unit receives information with a parameter indicating the state from the power supply apparatus.

8. The power reception apparatus according to claim 7, further comprising:
a power accumulation unit configured to accumulate power received by the power reception unit,
wherein, when the communication unit receives the information with the parameter indicating the predetermined state from the power supply apparatus, the power reception unit suspends the power reception from the power supply apparatus and starts to operate using the power accumulated in the power accumulation unit.

9. The power reception apparatus according to claim 7, further comprising:
a message transmission unit configured to transmit a predetermined message corresponding to the predetermined state to a previously specified another device when the communication unit receives the information with the parameter indicating the state from the power supply apparatus.

10. An information notification method, comprising the steps of:
supplying power to another device with which an agreement about a power specification for power supply is achieved;
accepting an input of one or more predetermined states from outside; and
communicating between power supplied in the step of supplying power and the another device using frequency dividing and communicating with the another device by applying a parameter indicating the predetermined state when the state is input in the step of accepting an input.
